(19) United States
(12) Patent Application Publication
(10) Pub. No.: US 2026/0186368 A1
(43) Pub. Date: Jul. 2, 2026

(54) ULTRASONIC LIGHT DEFLECTOR, ENDOSCOPE DEVICE, AND ULTRASONIC LIGHT DEFLECTION METHOD

(71) Applicant: The Doshisha, Kyoto (JP)

(72) Inventors: Daisuke KOYAMA, Kyoto (JP); Yuki HARADA, Kyoto (JP); Mutsuo ISHIKAWA, Kanagawa (JP)

(21) Appl. No.: 19/130,243

(22) PCT Filed: Nov. 7, 2023
(86) PCT No.: PCT/JP2023/040095

§ 371 Date: May 15, 2025

(30) Foreign Application Priority Data
Nov. 17, 2022 (JP) 2022-184142

(51) Int. Cl. G02F 1/33

(52) U.S. Cl. CPC G02F 1/332

(57) ABSTRACT

An ultrasonic light deflector 1 including an ultrasound emission unit 2 that emits ultrasound and a transparent material part 3 through which ultrasound propagates and through which light is transmitted, in which the ultrasound emission unit 2 emits ultrasound toward a light beam L in the transparent material part 3 so that the direction of travel of the light beam L in the transparent material part 3 and the direction of travel of the ultrasound intersect, and the transparent material part 3 produces a static refractive index change and causes the light beam L to deflect while the ultrasound is being emitted.

### DESCRIPTION

### Technical Field

The present invention relates to an ultrasonic light deflector, an endoscope device, and an ultrasonic light deflection method.

### Background Art

Conventionally, an endoscope device capable of directly observing a blood vessel wall, blood, and the like under a narrow environment in a blood vessel is known, and the endoscope device is used in, for example, an imaging system using optical coherence tomography (OCT). (See, for example, Patent Document 1.)

A conventional endoscope device, that is, a conventional OCT probe includes an optical fiber, a lens for image formation provided at a distal end portion of the optical fiber, and a reflecting member for reflecting measurement light that has passed through the lens in a radial direction of the probe.

As described above, since the conventional endoscope device has a configuration including the lens, the endoscope device is restricted by the lens (for example, restricted in the focal length and the viewing angle). As a result, in the conventional endoscope device, it is difficult to reduce the size and thickness of the entire device. In other words, if the lens can be eliminated, it is possible to reduce the size and thickness of the endoscope device, and thus, there is a demand for an alternative to the lens, the alternative being required to be smaller and thinner than the lens.

Meanwhile, as a diffraction-type ultrasonic light deflector, for example, one described in Patent Document 2 is known. The ultrasonic light deflector described in Patent Document 2 can selectively apply a high-frequency voltage to m ultrasonic transducers disposed in an acousto-optic member to cause Bragg diffraction, causing incident light to deflect in m directions. That is, the ultrasonic light deflector described in Patent Document 2 can obtain one beam of 0th-order light (non-diffracted light) and m beams of first-order diffracted light. However, the ultrasonic light deflector described in Patent Document 2 has the problem that energy loss occurs due to use of the diffracted light.

As another diffraction-type ultrasonic light deflector, for example, one described in Patent Document 3 is known. The ultrasonic light deflector described in Patent Document 3 includes an acousto-optic medium made of TeO₂ crystal and an ultrasonic transducer provided in the acousto-optic medium. In the ultrasonic light deflector described in Patent Document 3, ultrasound generated by the ultrasonic transducer has uniform intensity in the acousto-optic medium. The ultrasonic light deflector described in Patent Document 3 can obtain non-diffracted light and diffracted light located on the left and right of the non-diffracted light. However, the ultrasonic light deflector described in Patent Document 3 also has the problem that energy loss occurs when the diffracted light is used.

Furthermore, as an ultrasonic light deflector for visualizing ultrasonic pulses, for example, one described in Patent Document 4 is known. The ultrasonic light deflector described in Patent Document 4 includes a first optical system having a polarizing plate, a pair of a second optical system and a third optical system for polarized light from the first optical system to enter, an ultrasonic transducer (observation unit) provided between the second optical system and the third optical system, a knife edge that allows a part of transmitted light having transmitted through the observation unit to pass through, and a fourth optical system that visualizes the light having passed through the knife edge. The ultrasonic light deflector described in Patent Document 4 can simultaneously visualize ultrasonic pulses in water and solid. However, the ultrasonic light deflector described in Patent Document 4 also has the problem that an energy loss occurs in the process of passing through each optical system.

### PRIOR ART DOCUMENTS

### Patent Documents

Patent Document 1: JP-A-2009-98016
Patent Document 2: JP-A-60-214344
Patent Document 3: JP-A-1-285924
Patent Document 4: U.S. Pat. No. 4,788,866

### SUMMARY OF THE INVENTION

### Problems to be Solved by the Invention

The present invention has been made in view of the above circumstances, and an object of the present invention is to provide an ultrasonic light deflector and an endoscope device that can be reduced in the size and thickness, and an ultrasonic light deflection method thereof.

### Means for Solving the Problems

In order to achieve the above object, an ultrasonic light deflector according to the present invention includes:
an ultrasound emission unit that emits ultrasound; and
a transparent material part through which the ultrasound propagates and through which light is transmitted,
in which
the ultrasound emission unit emits the ultrasound toward transmitted light in the transparent material part so that a direction of travel of the transmitted light in the transparent material part and a direction of travel of the ultrasound intersect, and
the transparent material part produces a static refractive index change and causes the transmitted light to deflect while the ultrasound is being emitted.

In the ultrasonic light deflector,
the following configuration may be adopted:
the ultrasound emission unit emits, as the ultrasound, high-frequency strong ultrasound having a frequency of 10 MHz or more and a maximum value of a sound pressure of 1 MPa or more, and
the transparent material part converts energy of the high-frequency strong ultrasound into heat to produce the refractive index change.

In the ultrasonic light deflector,
the following configuration may be adopted:
the ultrasound emission unit emits, as the ultrasound, high-frequency strong ultrasound having a frequency of 10 MHz or more and a maximum value of a sound pressure of 1 MPa or more, and
the transparent material part is formed of liquid and/or gel, and generates cavitation bubbles due to a negative pressure of the high-frequency strong ultrasound to produce the refractive index change.

In the ultrasonic light deflector,
the following configuration may be adopted:
the transparent material part is a columnar body including one end surface, an opposite end surface, and an outer peripheral surface between the one end surface and the opposite end surface,
the transmitted light enters the one end surface and exits from the opposite end surface, and
the ultrasound emission unit includes:
an ultrasonic vibrator unit disposed on the outer peripheral surface; and
a control unit that vibrates the ultrasonic vibrator unit to cause the ultrasonic vibrator unit to emit the ultrasound.

In the ultrasonic light deflector,
the following configuration may be adopted:
the ultrasonic vibrator unit includes a plurality of ultrasonic transducers that vibrate in a thickness direction, and
the plurality of ultrasonic transducers are disposed side by side so as to surround the outer peripheral surface.

In the ultrasonic light deflector,
the following configuration may be adopted:
in order that a trajectory of the transmitted light on the opposite end surface of the transparent material part draws a closed loop, the control unit sequentially vibrates the plurality of ultrasonic transducers clockwise or counterclockwise when viewed from a side of the opposite end surface.

In order to achieve the above object, an endoscope device according to the present invention includes:
an optical fiber;
the ultrasonic light deflector according to the present invention provided at a distal end portion of the optical fiber; and
a reflecting member that is provided on a distal end side of the ultrasonic light deflector and reflects light emitted through the optical fiber and the ultrasonic light deflector.

In order to achieve the above object, an ultrasonic light deflection method according to the present invention is
an ultrasonic light deflection method of deflecting light using ultrasound, the method including:
a light emission step of emitting, using a transparent material part through which the ultrasound propagates and through which the light is transmitted, the light into the transparent material part; and
an ultrasound emission step of emitting the ultrasound toward transmitted light in the transparent material part such that a direction of travel of the transmitted light in the transparent material part and a direction of travel of the ultrasound intersect,
in which,
in the ultrasound emission step, emission of the ultrasound is continued for a predetermined time to produce a static refractive index change in the transparent material part to cause the transmitted light to deflect.

In the ultrasonic light deflection method,
the following configuration may be adopted:
in the ultrasound emission step, as the ultrasound, high-frequency strong ultrasound having a frequency of 10 MHz or more and a maximum value of a sound pressure of 1 MPa or more is emitted, and the transparent material part converts energy of the high-frequency strong ultrasound into heat.

In the ultrasonic light deflection method,
the following configuration may be adopted:
the transparent material part is formed of liquid and/or gel, and,
in the ultrasound emission step, as the ultrasound, high-frequency strong ultrasound having a frequency of 10 MHz or more and a maximum value of a sound pressure of 1 MPa or more is emitted to generate cavitation bubbles due to a negative pressure of the high-frequency strong ultrasound in the transparent material part.

In the ultrasonic light deflection method,
the following configuration may be adopted:
the transparent material part is a columnar body including one end surface, an opposite end surface, and an outer peripheral surface between the one end surface and the opposite end surface,
in the light emission step, the light is made to enter the one end surface and exit from the opposite end surface, and,
in the ultrasound emission step, with an ultrasonic vibrator unit being disposed on the outer peripheral surface, the ultrasonic vibrator unit is vibrated to cause the ultrasonic vibrator unit to emit the ultrasound.

In the ultrasonic light deflection method,
the following configuration may be adopted:
in the ultrasound emission step, with a plurality of ultrasonic transducers constituting the ultrasonic vibrator unit being disposed side by side so as to surround the outer peripheral surface of the transparent material part, the ultrasonic transducers are vibrated in a thickness direction.

In the ultrasonic light deflection method,
the following configuration may be adopted:
in the ultrasound emission step, in order that a trajectory of the transmitted light on the opposite end surface of the transparent material part draws a closed loop, the plurality of ultrasonic transducers are sequentially vibrated clockwise or counterclockwise when viewed from a side of the opposite end surface.

### Effects of the Invention

According to the present invention, it is possible to provide an ultrasonic light deflector and an endoscope device that can be reduced the size and thickness, and an ultrasonic light deflection method thereof.

### BRIEF DESCRIPTION OF THE DRAWINGS

FIG. 1 illustrate an ultrasonic light deflector (in an ultrasound OFF state) according to the present invention, of which FIG. 1(A) is a side view and FIG. 1(B) is a front view.

FIG. 2 illustrate the ultrasonic light deflector (in an ultrasound ON state) according to the present invention, of which FIG. 2(A) is a side view and FIG. 2(B) is a front view.

FIG. 3(A) is a diagram illustrating an OCT imaging system. FIG. 3(B) is a side view of an endoscope device of the present invention used in the OCT imaging system.

FIG. 4 is a control flowchart of an ultrasonic light deflection method according to the present invention.

FIG. 5 is a control flowchart illustrating closed-loop trajectory control of an ultrasound emission step of the ultrasonic light deflection method according to the present invention.

FIG. 6 are diagrams illustrating a refractive index change of an ultrasonic light deflector according to a modification, of which FIG. 6(A) is a diagram in the ultrasound OFF state, and FIG. 6(B) is a diagram in the ultrasound ON state.

FIG. 7 are diagrams illustrating refractive index distribution by a schlieren method of the ultrasonic light deflector according to the modification, of which FIG. 7(A) is a diagram in the ultrasound OFF state, and FIG. 7(B) is a diagram in the ultrasound ON state.

FIG. 8 are diagrams relating to refractive index distribution measurement, of which FIG. 8(A) is a diagram illustrating a measurement device, and FIG. 8(B) is a diagram illustrating measurement results.

### MODE FOR CARRYING OUT THE INVENTION

Hereinafter, embodiments of an ultrasonic light deflector, an endoscope device, and an ultrasonic light deflection method according to the present invention will be described with reference to the accompanying drawings.

### Ultrasonic Light Deflector

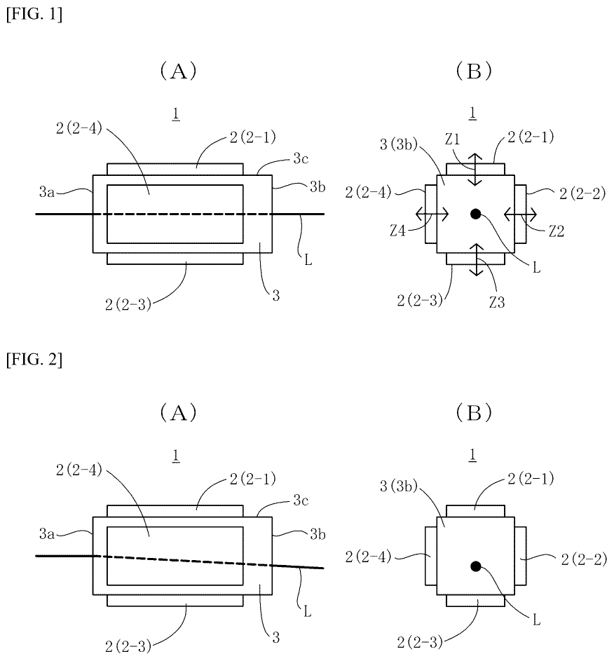

FIG. 1 illustrate an ultrasonic light deflector 1 according to an embodiment of the present invention. The ultrasonic light deflector 1 includes an ultrasound emission unit 2 and a transparent material part 3.

The ultrasound emission unit 2 includes at least one (in the present embodiment, four) ultrasonic transducer 2-1 to 2-4 that emits ultrasound and a control unit not illustrated that controls the ultrasonic transducers 2-1 to 2-4. The ultrasonic transducers 2-1 to 2-4 correspond to an “ultrasonic vibrator unit” of the present invention, and are connected to the control unit by a power cable not illustrated.

The transparent material part 3 is formed of at least one transparent material through which ultrasound propagates and through which light (in the present embodiment, a light beam L of visible light) is transmitted. In the present embodiment, glass will be described as an example of the transparent material, but liquid (for example, water) or gel may be used as the transparent material, or liquid or gel stored in a container made of glass or the like may be used as the transparent material part.

The transparent material part 3 is a columnar body (in the present embodiment, a columnar body having a quadrangular cross section) including one end surface 3a, an opposite end surface 3b, and an outer peripheral surface 3c between the one end surface 3a and the opposite end surface 3b. The transparent material part 3 is disposed such that the light beam L enters the one end surface 3a and exits from the opposite end surface 3b. Note that the light beam L reflected and scattered back from an observation target enters the opposite end surface 3b and exits from the one end surface 3a.

Of the outer peripheral surface 3c, the ultrasonic transducer 2-1 is disposed on the upper surface, the ultrasonic transducer 2-2 is disposed on the right side surface, the ultrasonic transducer 2-3 is disposed on the lower surface, and the ultrasonic transducer 2-4 is disposed on the left side surface.

The ultrasonic transducers 2-1 to 2-4 are constituted by, for example, a film of a piezoelectric body made of potassium niobate (KNbO₃) and an electrode film, and have a thickness of about 1 [μm] to 10 [μm]. As the piezoelectric body, lead zirconate titanate (PZT) may be used instead of potassium niobate (KNbO₃), or other piezoelectric materials may be used.

Furthermore, the piezoelectric body of the ultrasonic transducers 2-1 to 2-4 vibrates under the control of the control unit to emit ultrasound (high-frequency strong ultrasound) having a frequency of 100 [MHz] or more and a maximum value of sound pressure of 1 [MPa] or more.

The control unit applies an electric signal (in the present embodiment, an AC voltage signal) to the electrode film of the ultrasonic transducers 2-1 to 2-4 to vibrate the piezoelectric body of the ultrasonic transducers 2-1 to 2-4 in a thickness direction thereof. That is, the piezoelectric body of the ultrasonic transducer 2-1 is vibrated in a thickness direction Z1, the piezoelectric body of the ultrasonic transducer 2-2 is vibrated in a thickness direction Z2, the piezoelectric body of the ultrasonic transducer 2-3 is vibrated in a thickness direction Z3, and the piezoelectric body of the ultrasonic transducer 2-4 is vibrated in a thickness direction Z4. Z1 and Z3 are the same direction, and Z2 and Z4 are the same direction. Hereinafter, vibrating the piezoelectric body of the ultrasonic transducers 2-1 to 2-4 is simply referred to as vibrating the ultrasonic transducers 2-1 to 2-4.

Furthermore, for example, the control unit can change the frequency of the ultrasound emitted from the ultrasonic transducers 2-1 to 2-4 by changing the frequency of the electric signal, and can change the maximum value and the minimum value of the sound pressure of the ultrasound by changing an amplitude value of the electric signal. The control unit includes, for example, a function generator capable of applying pulse waves or continuous sine waves of an arbitrary frequency as an electric signal to the ultrasonic transducers 2-1 to 2-4. Furthermore, the control unit may include an amplifier for amplifying the amplitude of the electric signal of the function generator between the function generator and the ultrasonic transducers 2-1 to 2-4.

The ultrasound emitted from the ultrasonic transducers 2-1 to 2-4 travels toward the transmitted light of the light beam L in the transparent material part 3. That is, the ultrasonic transducers 2-1 to 2-4 emit ultrasound so that the direction of travel of the transmitted light of the light beam L in the transparent material part 3 and the direction of travel of the ultrasound intersect. For example, when ultrasound (high-frequency strong ultrasound) having a frequency of 100 [MHz] or more and a maximum value of sound pressure of 1 [MPa] or more is emitted, the transparent material part 3 converts energy of the ultrasound into heat to produce a temperature change in the transparent material, thereby producing a static refractive index change in the transparent material. As a result, the transparent material part 3 can cause the transmitted light of the light beam L to deflect while the ultrasound is being emitted.

FIG. 2 illustrate the ultrasonic light deflector 1 when the ultrasonic transducer 2-1 is vibrated. In FIG. 2, only the ultrasonic transducer 2-1 vibrates and emits ultrasound, and the ultrasonic transducers 2-2 to 2-4 are not vibrating (are not emitting ultrasound).

In this case, the transparent material in the transparent material part 3 has a portion closer to the ultrasonic transducer 2-1 where the temperature rise becomes larger, and a portion farther from the ultrasonic transducer 2-1 where the temperature rise becomes smaller. That is, in the transparent material part 3, a portion closer to the ultrasonic transducer 2-1 undergoes a larger refractive index change, and a portion farther from the ultrasonic transducer 2-1 undergoes a smaller refractive index change. As a result, as illustrated in FIG. 2, in the transparent material part 3, the transmitted light of the light beam L is deflected in a direction away from the ultrasonic transducer 2-1.

Similarly, when only the ultrasonic transducer 2-2 is vibrated, the transmitted light of the light beam L is deflected in a direction away from the ultrasonic transducer 2-2, when only the ultrasonic transducer 2-3 is vibrated, the transmitted light of the light beam L is deflected in a direction away from the ultrasonic transducer 2-3, and when only the ultrasonic transducer 2-4 is vibrated, the transmitted light of the light beam L is deflected in a direction away from the ultrasonic transducer 2-4.

Therefore, according to the ultrasonic light deflector 1 according to the present embodiment, the transmitted light of the light beam L in the transparent material part 3 can be deflected in an arbitrary direction by controlling the ultrasonic transducers 2-1 to 2-4 by the control unit. For example, by sequentially vibrating the ultrasonic transducers 2-1 to 2-4 clockwise or counterclockwise when viewed from the front under the control of the control unit, the transmitted light of the light beam L can be deflected such that the trajectory of the light beam L on the opposite end surface 3b (the trajectory of an emission point of the light beam L) draws a closed loop.

In addition, according to the ultrasonic light deflector 1 according to the present embodiment, since both the ultrasound emission unit 2 and the transparent material part 3 can be reduced the size and thickness, it is possible to reduce the size and thickness as a whole. Furthermore, unlike a diffraction-type ultrasonic light deflector using diffracted light, the ultrasonic light deflector 1 according to the present embodiment produces a static refractive index change to cause the transmitted light of the light beam L to directly deflect, and thus, it is possible to suppress energy loss.

### Endoscope Device

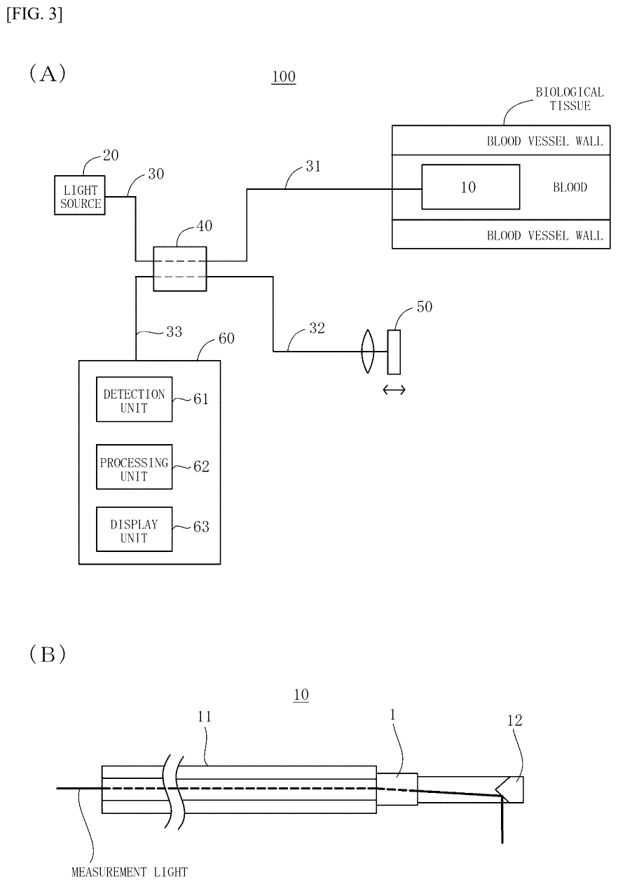

FIG. 3(A) illustrates an OCT imaging system 100 including an endoscope device 10 according to the present embodiment, and FIG. 3(B) illustrates a side view of the endoscope device 10. The OCT imaging system 100 is an imaging system using optical coherence tomography (OCT).

The OCT imaging system 100 includes the endoscope device 10 corresponding to an OCT probe, a light source 20, optical fibers 30 to 33, an interferometer 40, a reference light mirror 50, and a tomographic image forming device 60. The OCT imaging system 100 has the same configuration as the conventional OCT imaging system except for the endoscope device 10.

In the OCT imaging system 100, low coherence light is emitted from the light source 20 constituted by a light emitting diode or the like, is guided to the optical fiber 30 to enter the interferometer 40. The low coherence light having entered the interferometer 40 is branched into two systems in the interferometer 40, one of which is guided to the optical fiber 31 as measurement light to enter the endoscope device 10, and the other of which is guided to the optical fiber 32 as reference light to enter the reference light mirror 50.

The measurement light (corresponding to the “light beam L”) is emitted, by the endoscope device 10, to the biological tissue (in the present embodiment, into the blood vessel) to be observed. A part of the measurement light emitted into the blood vessel is reflected and scattered by the blood vessel wall or the blood, and returns to the endoscope device 10. The measurement light returned to the endoscope device 10 is guided to the optical fiber 31 and returned to the interferometer 40. On the other hand, the reference light having entered the reference light mirror 50 is reflected by the reference light mirror 50, guided to the optical fiber 32, and returned to the interferometer 40.

The measurement light and the reference light returned to the interferometer 40 interfere with each other in the interferometer 40. Specifically, depending on whether or not the optical path length difference between the returned measurement light and the returned reference light is an integral multiple of a half wavelength, the measurement light and the reference light are intensified or weakened to each other. Therefore, the depth direction distribution of the intensity of the returned measurement light can be obtained by moving the reference light mirror 50 along its optical axis, and the two-dimensional distribution of the intensity of the returned measurement light can be obtained by moving the reference light mirror 50 along the optical axis while moving the measurement light along the wall surface of the blood vessel wall.

The interference light between the measurement light and the reference light is guided to the optical fiber 33 and enters the tomographic image forming device 60. In the tomographic image forming device 60, a detection unit 61 detects the intensity and the like of the interference light, a processing unit 62 constructs a tomographic image on the basis of the detection result of the detection unit 61, and a display unit 63 displays the tomographic image thereof.

As illustrated in FIG. 3(B), the endoscope device 10 according to the present embodiment includes an optical fiber 11, the ultrasonic light deflector 1, a reflecting member 12, and an exterior part (not illustrated) that surrounds at least the outer peripheries of the optical fiber 11 and the ultrasonic light deflector 1.

A proximal end side (a side opposite to the ultrasonic light deflector 1) of the optical fiber 11 is connected to the optical fiber 31. The optical fiber 11 may be constituted by an optical fiber different from the optical fiber 31, or a part (distal end portion) of the optical fiber 31 may be the optical fiber 11.

The ultrasonic light deflector 1 is provided at the distal end portion of the optical fiber 11. In the present embodiment, the transparent material part 3 has a different configuration from the optical fiber 11. However, when the core of the optical fiber 11 is made of glass, the distal end portion of the core of the optical fiber 11 may be the transparent material part 3. Furthermore, it is preferable that the control unit that controls the ultrasonic transducers 2-1 to 2-4 is disposed outside the observation target. Furthermore, it is preferable that the piezoelectric body of the ultrasonic transducers 2-1 to 2-4 vibrates under the control of the control unit to emit ultrasound (high-frequency strong ultrasound) having a frequency of 100 [MHz] or more and a maximum value of sound pressure of 1 [MPa] or more.

The reflecting member 12 is provided on the distal end side of the ultrasonic light deflector 1 to be separated from the ultrasonic light deflector 1. The reflecting member 12 is configured to reflect the measurement light emitted from the ultrasonic light deflector 1 in the radial direction of the probe. As the reflecting member 12, for example, a cone mirror can be used.

In the endoscope device 10 according to the present embodiment, by controlling the ultrasonic transducers 2-1 to 2-4 of the ultrasonic light deflector 1, the transmitted light of the measurement light can be deflected in the transparent material part 3 in an arbitrary direction. For example, by sequentially vibrating the ultrasonic transducers 2-1 to 2-4 clockwise or counterclockwise when viewed from the front, the measurement light (transmitted light) in the transparent material part 3 can be deflected such that the trajectory of the measurement light entering the reflecting member 12 draws a closed loop. As a result, the measurement light can be emitted in the entire circumferential direction (360°) of the endoscope device 10 (OCT probe).

That is, in the endoscope device 10 according to the present embodiment, since the ultrasonic light deflector 1 can have a function of a lens for image formation, a lens, which is an essential constituent in the conventional endoscope device, becomes unnecessary. Moreover, the ultrasonic light deflector 1 can be further reduced the size and thickness than the lens. Therefore, according to the endoscope device 10 of the present embodiment, size and thickness can be reduced as the entire device.

Note that, in the present embodiment, the endoscope device 10 has been described as an OCT probe of the OCT imaging system 100, but the endoscope device 10 can also be applied as a probe of another imaging system.

### Ultrasonic Light Deflection Method

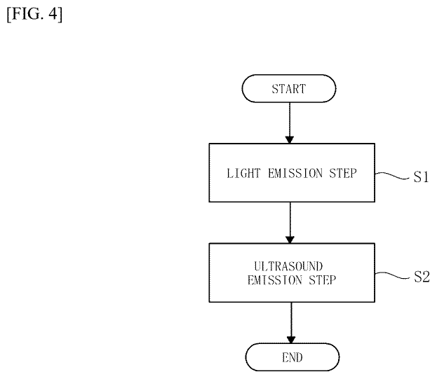

FIG. 4 is a control flowchart of an ultrasonic light deflection method according to an embodiment of the present invention. The ultrasonic light deflection method according to the present embodiment is a method performed using the ultrasonic light deflector 1, and includes a light emission step S1 and an ultrasound emission step S2.

In the light emission step S1, the light beam L is emitted to the transparent material part 3 of the ultrasonic light deflector 1. The light beam L enters the one end surface 3a of the transparent material part 3 and exits from the opposite end surface 3b of the transparent material part 3. In a case where the ultrasonic light deflector 1 is applied to the endoscope device 10, in the light emission step S1, the light source 20 is turned on, and measurement light is emitted to the transparent material part 3.

In the ultrasound emission step S2, ultrasound is emitted from the ultrasonic transducers 2-1 to 2-4 toward the transmitted light of the light beam L in the transparent material part 3. As a result, the direction of travel of the transmitted light of the light beam L in the transparent material part 3 and the direction of travel of the ultrasound intersect. In a case where the ultrasonic light deflector 1 is applied to the endoscope device 10, the light beam L is measurement light.

In the ultrasound emission step S2, the piezoelectric body of the ultrasonic transducers 2-1 to 2-4 is vibrated under the control of the control unit to emit ultrasound (high-frequency strong ultrasound) having a frequency of 100 [MHz] or more and a maximum value of sound pressure of 1 [MPa] or more. In the ultrasound emission step S2, by continuing the emission of the ultrasound for a predetermined time, a static refractive index change is produced in the transparent material part 3 to cause the transmitted light of the light beam L (or the measurement light) to deflect.

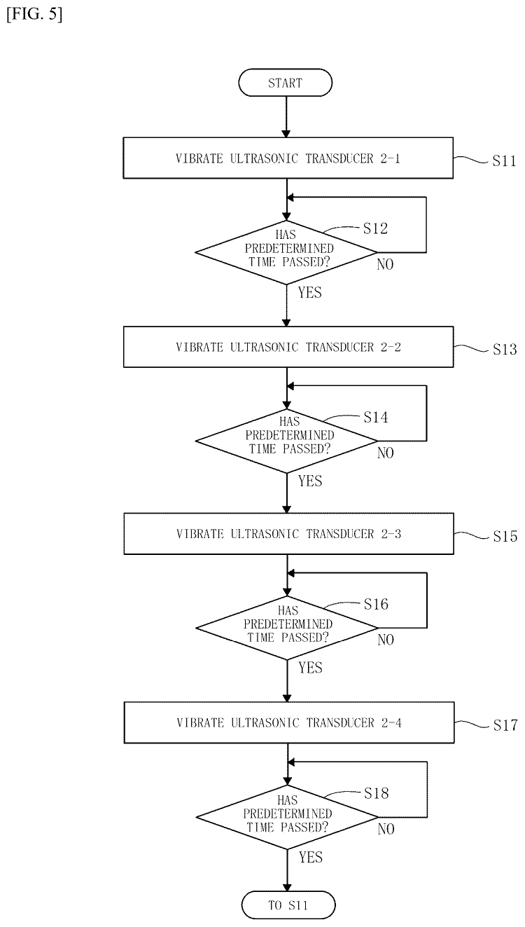

The ultrasound emission step S2 may include closed-loop trajectory control illustrated in FIG. 5. The closed-loop trajectory control is control in which the trajectory of the light beam L on the opposite end surface 3b of the transparent material part 3 becomes a closed loop, and is control for emitting the measurement light in the entire circumferential direction (360°) of the probe in a case where the ultrasonic light deflector 1 is applied to the endoscope device 10 (OCT probe).

In the closed-loop trajectory control, first, only the ultrasonic transducer 2-1 is vibrated (S11). As a result, the ultrasound is emitted only from the ultrasonic transducer 2-1 and, in the transparent material part 3, a portion closer to the ultrasonic transducer 2-1 undergoes a larger temperature rise, and a portion farther from the ultrasonic transducer 2-1 undergoes a smaller temperature rise. That is, in the transparent material part 3, a portion closer to the ultrasonic transducer 2-1 undergoes a larger refractive index change, and a portion farther from the ultrasonic transducer 2-1 undergoes a smaller refractive index change. As a result, in the transparent material part 3, the transmitted light of the light beam L (or the measurement light) is deflected in a direction away from the ultrasonic transducer 2-1.

When the predetermined time has passed as the ultrasound emission time by the ultrasonic transducer 2-1 (YES in S12), only the ultrasonic transducer 2-2 is vibrated (S13). The predetermined time in step S12 is set to be equal to or longer than the time required for the ultrasound of the ultrasonic transducer 2-1 to produce a static refractive index change in the transparent material part 3.

By vibrating only the ultrasonic transducer 2-2, the ultrasound is emitted only from the ultrasonic transducer 2-2 and, in the transparent material part 3, a portion closer to the ultrasonic transducer 2-2 undergoes a larger temperature rise, and a portion farther from the ultrasonic transducer 2-2 undergoes a smaller temperature rise. That is, in the transparent material part 3, a portion closer to the ultrasonic transducer 2-2 undergoes a larger refractive index change, and a portion farther from the ultrasonic transducer 2-2 undergoes a smaller refractive index change. As a result, in the transparent material part 3, the transmitted light of the light beam L (or the measurement light) is deflected in a direction away from the ultrasonic transducer 2-2.

When the predetermined time has passed as the ultrasound emission time by the ultrasonic transducer 2-2 (YES in S14), only the ultrasonic transducer 2-3 is vibrated (S15). The predetermined time in step S14 is set to be equal to or longer than the time required for the ultrasound of the ultrasonic transducer 2-2 to produce a static refractive index change in the transparent material part 3.

By vibrating only the ultrasonic transducer 2-3, the ultrasound is emitted only from the ultrasonic transducer 2-3 and, in the transparent material part 3, a portion closer to the ultrasonic transducer 2-3 undergoes a larger temperature rise, and a portion farther from the ultrasonic transducer 2-3 undergoes a smaller temperature rise. That is, in the transparent material part 3, a portion closer to the ultrasonic transducer 2-3 undergoes a larger refractive index change, and a portion farther from the ultrasonic transducer 2-3 undergoes a smaller refractive index change. As a result, in the transparent material part 3, the transmitted light of the light beam L (or the measurement light) is deflected in a direction away from the ultrasonic transducer 2-3.

When the predetermined time has passed as the ultrasound emission time by the ultrasonic transducer 2-3 (YES in S16), only the ultrasonic transducer 2-4 is vibrated (S17). The predetermined time in step S16 is set to be equal to or longer than the time required for the ultrasound of the ultrasonic transducer 2-3 to produce a static refractive index change in the transparent material part 3.

By vibrating only the ultrasonic transducer 2-4, the ultrasound is emitted only from the ultrasonic transducer 2-4 and, in the transparent material part 3, a portion closer to the ultrasonic transducer 2-4 undergoes a larger temperature rise, and a portion farther from the ultrasonic transducer 2-4 undergoes a smaller temperature rise. That is, in the transparent material part 3, a portion closer to the ultrasonic transducer 2-4 undergoes a larger refractive index change, and a portion farther from the ultrasonic transducer 2-4 undergoes a smaller refractive index change. As a result, in the transparent material part 3, the transmitted light of the light beam L (or the measurement light) is deflected in a direction away from the ultrasonic transducer 2-4.

When the predetermined time has passed as the ultrasound emission time by the ultrasonic transducer 2-4 (YES in S18), the process proceeds to step S11 again. The predetermined time in step S18 is set to be equal to or longer than the time required for the ultrasound of the ultrasonic transducer 2-4 to produce a static refractive index change in the transparent material part 3.

As a result of the closed-loop trajectory control described above, the trajectory of the light beam L on the opposite end surface 3b of the transparent material part 3 becomes a closed loop, and the measurement light can be emitted in the entire circumferential direction (360°) of the probe in a case where the ultrasonic light deflector 1 is applied to the endoscope device 10 (OCT probe).

Note that the ultrasonic transducers 2-1 to 2-4 preferably emit ultrasound having the same frequency and the same intensity (sound pressure maximum value), but may emit ultrasound having different frequencies and/or different intensities. Furthermore, the control unit of the ultrasonic transducers 2-1 to 2-4 may perform variable control of varying the frequency and/or amplitude of the electric signal applied to the ultrasonic transducers 2-1 to 2-4 so as to vary the frequency and/or the sound pressure in a range where the frequency of the ultrasound is 100 [MHz] or more and the maximum value of the sound pressure is 1 [MPa] or more.

Furthermore, the predetermined times in steps S12, S14, S16, and S18 are preferably the same time (for example, in the order of several hundred milliseconds in total), but may be different times. Furthermore, when the variable control is performed, the predetermined times in steps S12, S14, S16, and S18 may be changed between the steady state and the transient state of the ultrasound.

### Modification

Although the embodiments of the ultrasonic light deflector, the endoscope device, and the ultrasonic light deflection method according to the present invention have been described above, the present invention is not limited to the above embodiments.

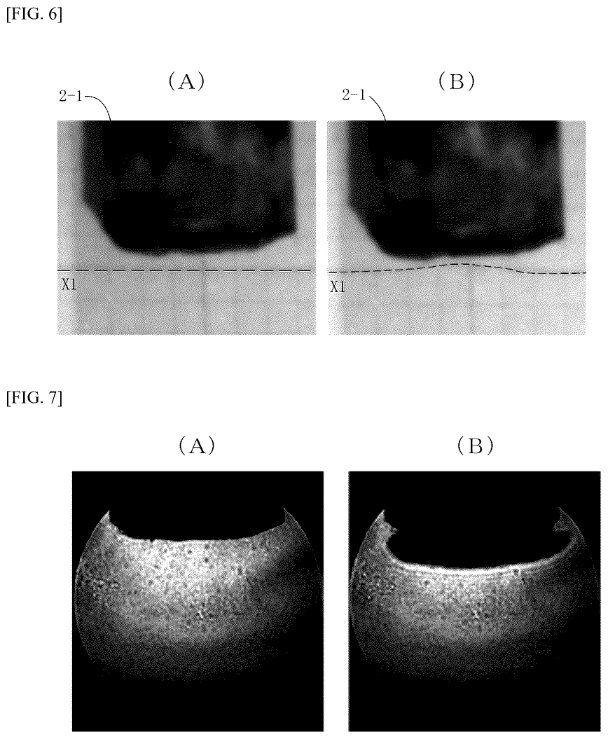

FIG. 6 illustrate a refractive index change by an ultrasonic light deflector according to a modification of the present invention. The ultrasonic light deflector according to the modification includes an ultrasound emission unit including the ultrasonic transducer 2-1 and a control unit thereof, and a transparent material part formed by filling a glass container with water.

In the modification, the ultrasonic transducer 2-1 has a distal end portion, at least which is disposed in the transparent material part, and emits ultrasound downward. Graph paper is disposed outside the transparent material part (on the back side in FIG. 6). The direction of travel of the transmitted light in the transparent material part is the depth direction in the diagrams.

FIG. 6(A) is a diagram when the ultrasonic transducer 2-1 is not vibrated (in an ultrasound OFF state), and FIG. 6(B) is a diagram when the ultrasonic transducer 2-1 is vibrated (in an ultrasound ON state). In FIG. 6(A), a horizontal line X1 of the graph paper seems to be a straight line, whereas in FIG. 6(B), distortion is seen in the central portion of the horizontal line X1 of the graph paper. Therefore, it can be seen that a static refractive index change is produced in the transparent material part due to the ultrasound of the ultrasonic transducer 2-1.

FIG. 7 illustrate a refractive index distribution by the ultrasonic light deflector according to the modification. The refractive index distribution is prepared by a schlieren method. FIG. 7(A) is a diagram when the ultrasonic transducer 2-1 is not vibrated (in the ultrasound OFF state), and FIG. 7(B) is a diagram when the ultrasonic transducer 2-1 is vibrated (in the ultrasound ON state).

In the schlieren method, a region where light is refracted is black (However, the ultrasonic transducer 2-1 is also black.), and a region where light is not refracted is white. Comparing FIG. 7(A) with FIG. 7(B), the black region increases and the white region decreases in FIG. 7(B). Therefore, it can be seen that a static refractive index change is produced in the transparent material part due to the ultrasound of the ultrasonic transducer 2-1. Note that a static refractive index change Δn in the ultrasonic light deflector of the modification is approximately Δn=0.02.

When the transparent material part is liquid as in the above modification, a refractive index change due to cavitation bubbles is produced in addition to a refractive index change due to a temperature change. Specifically, when the amplitude of the ultrasound exceeds the atmospheric pressure existing in the liquid, the negative pressure of the ultrasound generates microcavities (cavities) in the liquid, which become air bubbles (bubbles). These air bubbles are cavitation bubbles, and the cavitation bubbles have a diameter of the order of nano to submicron.

When the ultrasonic transducer of the ultrasound emission unit is vibrated, in the liquid transparent material part, a portion closer to the ultrasonic transducer undergoes generation of more cavitation bubbles. As the number of cavitation bubbles increases, the refractive index of the transparent material part approaches that of air (bubbles). That is, in the transparent material part, a portion closer to the ultrasonic transducer undergoes a larger refractive index change, and a portion farther from the ultrasonic transducer undergoes a smaller refractive index change.

Note that, also when the transparent material part is gel, a refractive index change due to cavitation bubbles is produced in addition to a refractive index change due to a temperature change. However, in the case of gel, the amount of cavitation bubbles generated depends on the viscosity of the gel. For example, when the gel has a high viscosity, the amount of cavitation bubbles generated decreases, and when the gel has a low viscosity, the amount of cavitation bubbles generated increases.

### (Measurement of Refractive Index Distribution)

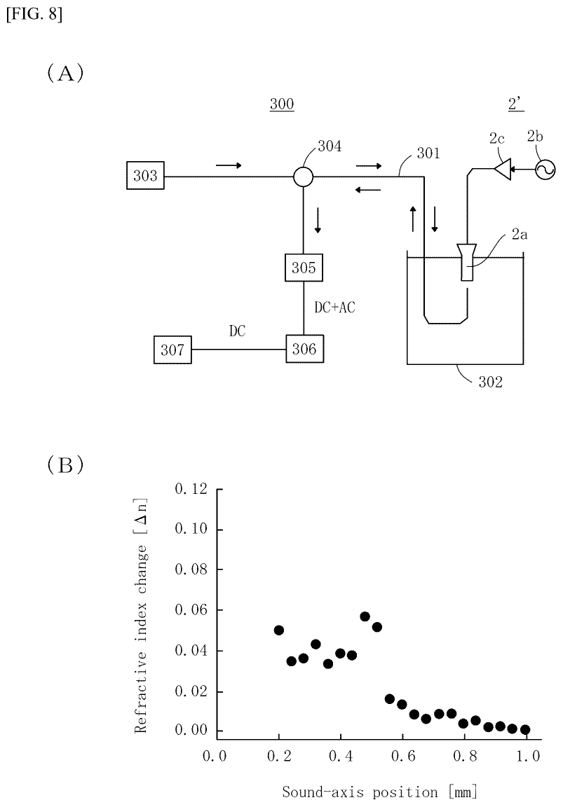

Next, the refractive index distribution measurement (in the sound-axis direction) will be described with reference to FIG. 8. Here, as illustrated in FIG. 8(A), the refractive index distribution measurement in water was performed using an optical fiber sensor device 300 and an ultrasound emission unit 2′.

The optical fiber sensor device 300 is constituted by a single-mode optical fiber 301, an acrylic water tank 302 containing water, an ASE light source 303, an optical circulator 304, a photodetector 305, a frequency filter 306, and a digital oscilloscope 307.

The ultrasound emission unit 2 includes an ultrasonic transducer 2a, a function generator 2b, and a high-frequency amplifier 2c. The distal end portion of the ultrasonic transducer 2a is disposed in the water tank 302 (in water) so as to face the distal end of the optical fiber 301.

The ultrasonic transducer 2a includes a film of a piezoelectric body made of potassium niobate (KNbO₃) at its distal end portion. The function generator 2b outputs an electric signal of a continuous sine wave of 160 [MHz] to the high-frequency amplifier 2c. The high-frequency amplifier 2c amplifies the amplitude of the electric signal by 51 [dB] and applies the amplified electric signal to the ultrasonic transducer 2a. That is, to the ultrasonic transducer 2a, an electric signal having a frequency of 160 [MHz] and a peak-to-peak voltage of 92 [Vpp] is applied. As a result, from the ultrasonic transducer 2a, ultrasound (high-frequency strong ultrasound) having a frequency of 100 [MHz] or more and a maximum value of sound pressure of 1 [MPa] or more is emitted.

In the optical fiber sensor device 300, incident light having entered the optical fiber 301 from the ASE light source 303 is reflected by the distal end of the optical fiber 301 and input to the photodetector 305 via the optical circulator 304. The photodetector 305 converts the input signal into an electric signal and outputs the converted electric signal to the frequency filter 306. The frequency filter 306 removes an AC component of the electric signal and outputs a DC electric signal to the digital oscilloscope 307. The digital oscilloscope 307 measures a DC electric signal when the ultrasonic transducer 2a is outputting ultrasound and a DC electric signal when the ultrasonic transducer 2a is not outputting ultrasound, enabling calculation of the refractive index change Δn.

FIG. 8(B) illustrates a refractive index change Δn in water in the sound-axis direction. In FIG. 8(B), assuming that the refractive index of the optical fiber 301 (glass) was 1.46, the refractive index of water was 1.33, the refractive index change Δn was calculated using the Fresnel reflectance equation. The horizontal axis in FIG. 8(B) indicates the distance between the distal end of the ultrasonic transducer 2a and the distal end of the optical fiber 301. In this measurement, the ultrasonic transducer 2a was fixed, and the optical fiber 301 was moved. The vertical axis in FIG. 8(B) indicates the refractive index change Δn. The refractive index change Δn=0.00 corresponds to the refractive index of water, and the refractive index change Δn=0.33 corresponds to the refractive index of air.

As illustrated in FIG. 8(B), it can be seen that when the distance from the distal end of the ultrasonic transducer 2a to the distal end of the optical fiber 301 is in the range of 0.20 to 0.52 [mm], the refractive index change Δn increases, and the refractive index in water approaches the refractive index of air. This static refractive index change Δn is produced by generation of cavitation bubbles due to ultrasound (high-frequency strong ultrasound) in addition to temperature change due to ultrasound (high-frequency strong ultrasound). That is, in the present invention, by varying the intensity of the ultrasound, the refractive index distribution in the medium (in this measurement, in water) can be statically controlled.

Note that, usually, when the refractive index distribution in the medium is controlled using the pressure fluctuation of the ultrasound, the refractive index change Δn is dynamic. That is, the refractive index distribution temporally changes with pressure fluctuation. On the other hand, in the present invention, the refractive index distribution in the medium is controlled by the temperature change produced by the ultrasound (high-frequency strong ultrasound) and the number density gradient of the cavitation bubbles. Therefore, in the present invention, the refractive index change Δn can be statically controlled (that is, constantly controlled without temporally changing in a steady state).

### Other Modifications

As long as the ultrasonic light deflector according to the present invention includes an ultrasound emission unit that emits ultrasound and a transparent material part through which ultrasound propagates and through which light is transmitted, in which the ultrasound emission unit emits ultrasound toward transmitted light in the transparent material part so that the direction of travel of the transmitted light in the transparent material part and the direction of travel of the ultrasound intersect, and the transparent material part produces a static refractive index change and causes the transmitted light to deflect while the ultrasound is being emitted, a configuration thereof can be appropriately changed.

In the above embodiment, although the direction of travel of the transmitted light in the transparent material part and the direction of travel of the ultrasound are orthogonal to each other, it suffices that the directions intersect even if the directions are not orthogonal. That is, the ultrasound emission unit may be disposed on the outer periphery or the inside of the transparent material part so as to emit ultrasound from an oblique direction toward the transmitted light in the transparent material part.

In the above embodiment, as ultrasound, high-frequency strong ultrasound having a frequency of 100 [MHz] or more and a maximum value of sound pressure of 1 [MPa] or more is emitted. However, as long as the transparent material part produces a temperature change by converting energy of the ultrasound into heat and produces a static refractive index change, ultrasound having an arbitrary frequency and/or sound pressure can be used. For example, although the region where the static refractive index change is produced is narrowed, ultrasound having 10 [MHz] or more (preferably 30 [MHz] or more) and a maximum value of the sound pressure of 1 [MPa] or more (This ultrasound is also referred to as high-frequency strong ultrasound.) may be used.

In the above embodiment, the example in which the ultrasonic light deflector is used in the endoscope device has been described, but the ultrasonic light deflector of the present invention is also applicable to devices other than the endoscope device.

In the above embodiment, the closed-loop trajectory control is performed in which, in order that the trajectory of the light beam on the opposite end surface of the transparent material part draws a closed loop, the plurality of ultrasonic transducers are sequentially vibrated clockwise or counterclockwise when viewed from the side of the opposite end surface. However, in the closed-loop trajectory control, two or more ultrasonic transducers may be simultaneously vibrated according to the number of ultrasonic transducers. For example, when the ultrasonic light deflector includes eight ultrasonic transducers, the ultrasonic transducers may be sequentially vibrated clockwise or counterclockwise in units of two adjacent ultrasonic transducers.

As long as the ultrasonic light deflection method according to the present invention is an ultrasonic light deflection method of deflecting light using ultrasound, the method including: a light emission step of emitting, using a transparent material part through which the ultrasound propagates and through which the light is transmitted, the light into the transparent material part ; and an ultrasound emission step of emitting the ultrasound toward the transmitted light in the transparent material part such that a direction of travel of the transmitted light in the transparent material part and a direction of travel of the ultrasound intersect, in which, in the ultrasound emission step, emission of the ultrasound is continued for a predetermined time to produce a static refractive index change in the transparent material part to cause the transmitted light to deflect, the configuration thereof can be appropriately changed.

### DESCRIPTION OF REFERENCE SIGNS

1 Ultrasonic light deflector
2 Ultrasound emission unit
2-1 to 2-4 Ultrasonic transducer
3 Transparent material part
3a One end surface
3b Opposite end surface
3c Outer peripheral surface
10 Endoscope device
11 Optical fiber
12 Reflecting member
20 Light source
30 to 33 Optical fiber
40 Interferometer
50 Reference light mirror
60 Tomographic image forming device
61 Detection unit
62 Processing unit
63 Display unit
100 OCT imaging system

1. An ultrasonic light deflector comprising:
an ultrasound emission unit that emits ultrasound; and
a transparent material part through which the ultrasound propagates and through which light is transmitted,
wherein the ultrasound emission unit emits the ultrasound toward transmitted light in the transparent material part so that a direction of travel of the transmitted light in the transparent material part and a direction of travel of the ultrasound intersect, and
the transparent material part produces a static refractive index change and causes the transmitted light to deflect while the ultrasound is being emitted.

2. The ultrasonic light deflector according to claim 1, wherein
the ultrasound emission unit emits, as the ultrasound, high-frequency strong ultrasound having a frequency of 10 MHz or more and a maximum value of a sound pressure of 1 MPa or more, and
the transparent material part converts energy of the high-frequency strong ultrasound into heat to produce the refractive index change.

3. The ultrasonic light deflector according to claim 1, wherein
the ultrasound emission unit emits, as the ultrasound, high-frequency strong ultrasound having a frequency of 10 MHz or more and a maximum value of a sound pressure of 1 MPa or more, and
the transparent material part is formed of liquid and/or gel, and generates cavitation bubbles due to a negative pressure of the high-frequency strong ultrasound to produce the refractive index change.

4. The ultrasonic light deflector according to claim 1, wherein
the transparent material part is a columnar body including one end surface, an opposite end surface, and an outer peripheral surface between the one end surface and the opposite end surface,
the transmitted light enters the one end surface and exits from the opposite end surface, and
the ultrasound emission unit includes:
an ultrasonic vibrator unit disposed on the outer peripheral surface; and
a control unit that vibrates the ultrasonic vibrator unit to cause the ultrasonic vibrator unit to emit the ultrasound.

5. The ultrasonic light deflector according to claim 4, wherein
the ultrasonic vibrator unit includes a plurality of ultrasonic transducers that vibrate in a thickness direction, and
the plurality of ultrasonic transducers are disposed side by side so as to surround the outer peripheral surface.

6. The ultrasonic light deflector according to claim 5, wherein,
in order that a trajectory of the transmitted light on the opposite end surface of the transparent material part draws a closed loop, the control unit sequentially vibrates the plurality of ultrasonic transducers clockwise or counterclockwise when viewed from a side of the opposite end surface.

7. An endoscope device comprising:
an optical fiber;
the ultrasonic light deflector according to claim 1 provided at a distal end portion of the optical fiber; and
a reflecting member that is provided on a distal end side of the ultrasonic light deflector and reflects light emitted through the optical fiber and the ultrasonic light deflector.

8. An ultrasonic light deflection method of deflecting light using ultrasound, the method comprising:
a light emission step of emitting, using a transparent material part through which the ultrasound propagates and through which the light is transmitted, the light into the transparent material part; and
an ultrasound emission step of emitting the ultrasound toward transmitted light in the transparent material part such that a direction of travel of the transmitted light in the transparent material part and a direction of travel of the ultrasound intersect,
wherein, in the ultrasound emission step, emission of the ultrasound is continued for a predetermined time to produce a static refractive index change in the transparent material part to cause the transmitted light to deflect.

9. The ultrasonic light deflection method according to claim 8, wherein,
in the ultrasound emission step, as the ultrasound, high-frequency strong ultrasound having a frequency of 10 MHz or more and a maximum value of a sound pressure of 1 MPa or more is emitted, and the transparent material part converts energy of the high-frequency strong ultrasound into heat.

10. The ultrasonic light deflection method according to claim 8, wherein
the transparent material part is formed of liquid and/or gel, and,
in the ultrasound emission step, as the ultrasound, high-frequency strong ultrasound having a frequency of 10 MHz or more and a maximum value of a sound pressure of 1 MPa or more is emitted to generate cavitation bubbles due to a negative pressure of the high-frequency strong ultrasound in the transparent material part.

11. The ultrasonic light deflection method according to claim 8, wherein
the transparent material part is a columnar body including one end surface, an opposite end surface, and an outer peripheral surface between the one end surface and the opposite end surface,
in the light emission step, the light is made to enter the one end surface and exit from the opposite end surface, and,
in the ultrasound emission step, with an ultrasonic vibrator unit being disposed on the outer peripheral surface, the ultrasonic vibrator unit is vibrated to cause the ultrasonic vibrator unit to emit the ultrasound.

12. The ultrasonic light deflection method according to claim 11, wherein,
in the ultrasound emission step, with a plurality of ultrasonic transducers constituting the ultrasonic vibrator unit being disposed side by side so as to surround the outer peripheral surface of the transparent material part, the ultrasonic transducers are vibrated in a thickness direction.

13. The ultrasonic light deflection method according to claim 12, wherein,
in the ultrasound emission step, in order that a trajectory of the transmitted light on the opposite end surface of the transparent material part draws a closed loop, the plurality of ultrasonic transducers are sequentially vibrated clockwise or counterclockwise when viewed from a side of the opposite end surface.
